(19) United States
(12) Patent Application Publication
(10) Pub. No.: US 2005/0068487 A1
(43) Pub. Date: Mar. 31, 2005

(54) Method of manufacturing spacers of a liquid crystal display

(75) Inventors: Wen-Jiunn Hsieh, Chung Ho City (TW); Chih-Yu Chao, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: CHUNGHWA PICTURE TUBES, LTD., Taipei (TW)

(21) Appl. No.: 10/948,671

(22) Filed: Sep. 24, 2004

(30) Foreign Application Priority Data
Sep. 25, 2003 (TW) 92126550

(51) Int. Cl. G02F 1/1339

(52) U.S. Cl. 349/155

(57) ABSTRACT

A method of manufacturing spacers of a liquid crystal display (LCD) is described. A stamp having relief geometries is formed and then a spacer material is applied thereon. Then, the spacer material is left onto a surface of a substrate by the stamp. The spacer material is cured and the stamp is removed; spacers are thus formed on the substrate.

### RELATED PUBLICATION

The present application is based on, and claims priority from, Taiwan Application Serial Number 92126550, filed Sep. 25, 2003, the disclosure of which is hereby incorporated by reference herein in its entirety.

### BACKGROUND

1. Field of Invention

The present invention relates to a method of manufacturing a liquid crystal display. More particularly, the present invention relates to a method of manufacturing spacers of a liquid crystal display.

2. Description of Related Art

Currently, liquid crystal displays (LCDs) are widely applied in electrical products due to the rapid progress of optical technology and semiconductor technology. Moreover, with the advantages of high image quality, compact size, light weight, low driving voltage, and low power consumption, LCDs have been introduced into portable computers, personal digital assistants, and color televisions, and are gradually replacing the cathode ray tubes (CRT) used in conventional displays. LCDs are becoming the mainstream display apparatus.

The main part of an LCD is a liquid crystal (LC) unit composed of two parallel transparent substrates and LC sealed therein. The fabrication process of a TFT-LCD can be generally divided into four parts: TFT array process, color filter (CF) process, LC cell assembly process and liquid crystal module (LCM) process.

In the LC cell assembly process, spacers are spread on a substrate, and then another substrate is assembled in parallel to form a liquid crystal cell. Afterward, the liquid crystal material is injected into the liquid crystal cell, and then the injection port of the liquid crystal cell is sealed to finish the LC cell assembly process.

Generally, the spacers are spherical particles and are spread uniformly to keep the space between the two substrates. However, by this method, the light leakage occurs and the contrast ratio is decreased due to scattering the incident light by the spacers. Therefore, a photolithography process is used to fabricate photo-spacers made of photoresist material.

FIG. 1 to FIG. 3 illustrate schematic views of a conventional manufacturing process of photo-spacers. As illustrated in FIG. 1, a photoresist layer 12 is formed on a substrate with thin film transistors or color filters fabricated thereon. In FIG. 2, a photomask 14 is then used to expose the photoresist layer 12 by light emitted from a light source 18 through a pattern opening 16 of the photomask 14. In FIG. 3, the photoresist layer 12a serving as a spacer is formed on the substrate 10 after developing the photoresist layer 12.

The conventional method of manufacturing spacers requires exposure and development processes and is time-consuming. Moreover, most of the photoresist layer formed on the substrate is removed finally, and the production cost is thus increased.

### SUMMARY

It is therefore an aspect of the present invention to provide a method of manufacturing spacers of a liquid crystal display. In this method, spacers are formed by using microcontactprinting to save time and production cost.

In accordance with the foregoing and other aspects of the present invention, a method of manufacturing spacers of a liquid crystal display is provided. A stamping surface of a stamp has relief geometries. The quantities, shapes and positions of the relief geometries are decided according to customer request. A spacer material is applied on the stamping surface, and then the stamping surface is contacted with a surface of a substrate, such that the spacer material is left onto the substrate. Finally, the spacer material on the substrate is cured to form spacers.

According to one preferred embodiment of the present invention, the stamp can be formed by the following steps. A master mold having at least one slot is formed, and the quantity, shape and position of the slot are the same as those of the spacers on the substrate. A molding material covers the master mold to fill the slot. Then, the molding material is solidified and removed from the master mold to obtain the stamp.

The spacer material is applied either by directly spreading the spacer material on the stamping surface, or by pressing the stamp against a stamp pad containing the spacer material therein.

In the preferred embodiment, the stamp and the spacer material are polymers, and then they are solidified or cured by ultraviolet light or heating. The material of the stamp is preferably polydimethylsiloxane, and the spacer material is preferably acrylic polymer. The shape of stamp is a plate or a roller. The stamp can be separated from the spacer material before or after curing the spacer material.

The method of the invention omits the conventional exposure and development processes and thus decreases the processing time. In addition, the method forms the spacers only in their correct positions and thus saves the spacer material.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIGS. 1 to 3 are schematic views of a conventional manufacturing flow of spacers;

FIGS. 4 to 6 are schematic views of manufacturing the stamp according to one preferred embodiment of the invention;

FIGS. 7A to 9 are schematic views of stamping to form spacers by the stamp according to preferred embodiments of the invention; and

FIG. 10 is a schematic view of another embodiment of the stamp of the invention.

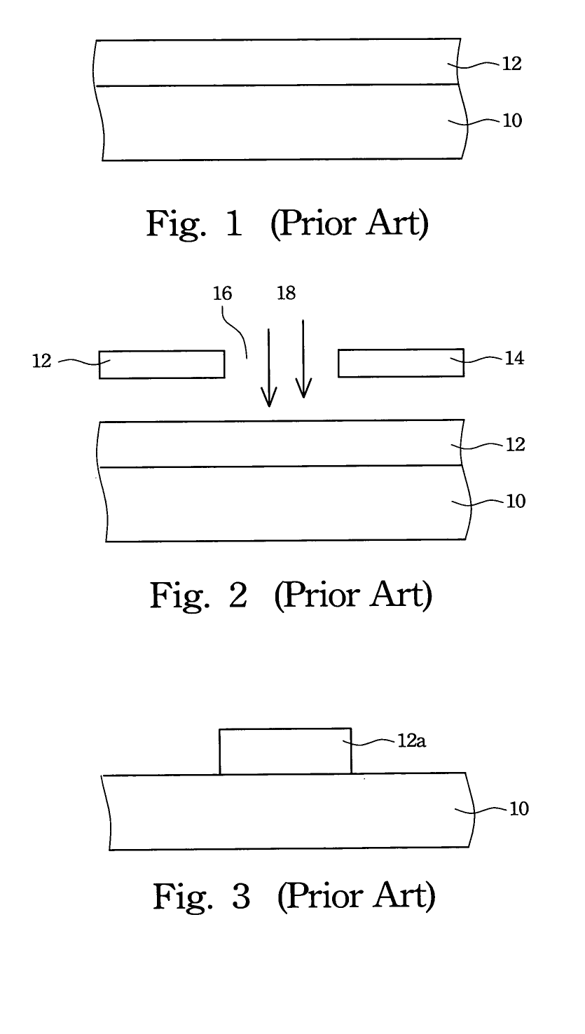

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

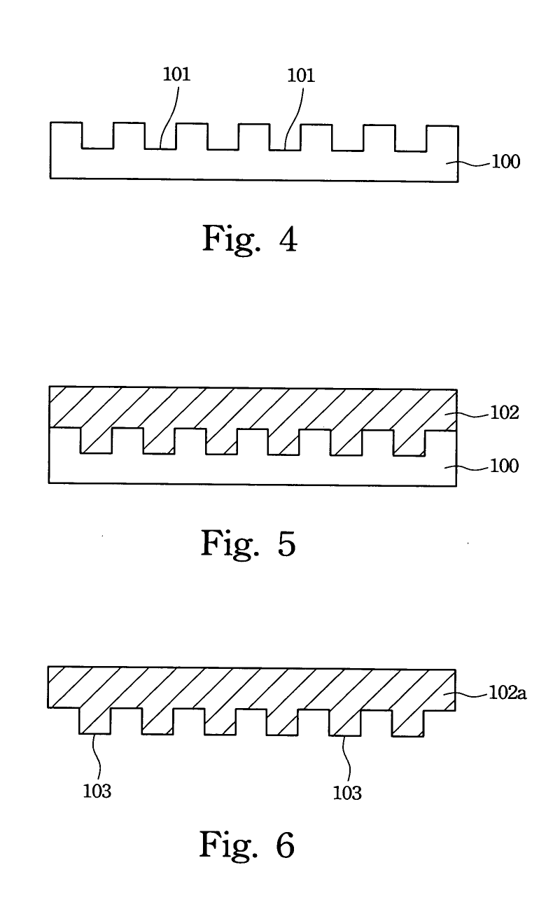

FIGS. 4 to 9 are schematic views of one preferred embodiment of the invention. In particular, FIGS. 4 to 6 illustrate the manufacturing of the stamp according to one preferred embodiment of the invention.

As illustrated in FIG. 4, a master mold 100 is fabricated. The material of the master mold 100 is not easily deformed, such as a mask or metal. A surface of the master mold 100 has several slots 101. The quantities, positions, bottom shapes and sizes of the slots 101 are the same as those of spacers subsequently formed by stamping.

As illustrated in FIG. 5, a molding material 102 (e.g. polymers) is used to cover the master mold 100. Generally, the molding material 102 is fluid to fill the slots 101 easily. In the preferred embodiment of the invention, the molding material 102 is polydimethylsiloxane (PDMS). However, the molding material 102 is not limited by the PDMS, and other suitable materials can also be used here. Afterward, a solidifying process is carried out to polymerize the molding material 102. In FIG. 6, the solidified molding material is separated from the master mold 100, and a stamp 102a is thus obtained. A surface of the stamp 102a has several relief geometries 103; the quantities, positions, shapes and sizes of these relief geometries 103 correspond to those of the slots 101 in FIG. 4.

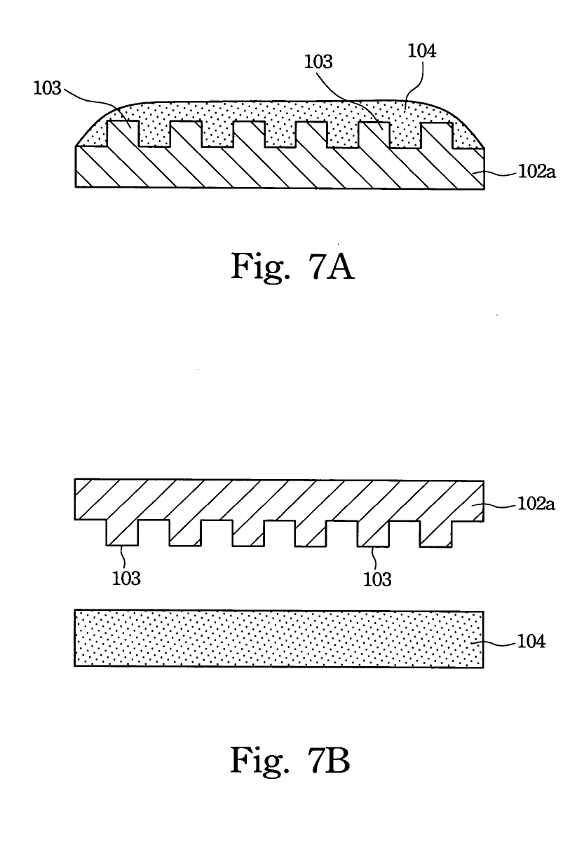

FIG. 7A to 9 are schematic views of a stamping process performed by the stamp to form spacers according to preferred embodiments of the invention.

Firstly, a spacer material made of polymer is applied on the stamp 102a. FIG. 7A and FIG. 7B are schematic views of two embodiments for illustrating how to apply the spacer material on the stamp 102a. As illustrated in FIG. 7A, the spacer material 104 is made as a solution for being spread on the stamp 102a. The spreading approach is preferably to adsorb the spacer material solution and then drip the same on the surface of the stamp 102a. Alternatively, as illustrated in FIG. 7B, the spacer material 104 can be made as a stamp pad. The stamp 102a is pressed against the stamp pad, and thus the relief geometries 103 of the stamp 102a adsorb the spacer material 104.

Generally, photoresists including organic materials, such as the acrylic organic polymer, can be selected as the spacer material. Since the spacers contact organic liquid (e.g. liquid crystal) for a long time, the spacer material must be selected by considering the strength, chemical resistance, thermal stability, and adhesion characteristics of the spacer material. However, these characteristics may be changed according to various requirements of different processing conditions, such as temperature, pressure, the material of the stamp, or the material of the substrate. Therefore, the invention does not limit the kinds of the spacer material 104.

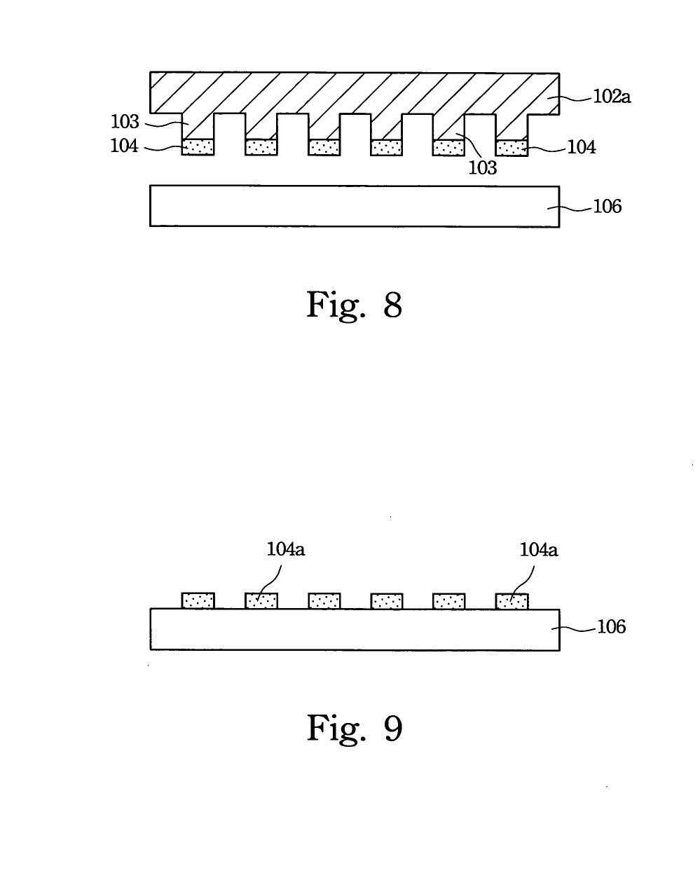

In FIG. 8, a contacting procedure is carried out. The stamp 102a with spacer material 104 thereon is brought into contact with a surface of a substrate 106 to transfer the spacer material 104 onto the substrate 106. The substrate 106 comprises thin film transistors or color filters. In FIG. 9, the spacer material 104 is stamped on the substrate 106 after the stamp 102a is removed. In addition, the spacer material 104 is cured to form the spacers 104a by an ultraviolet light irradiation or heating. Generally, the thicknesses of the spacers 104a are over about 20 nm. The curing can be carried out before or after the step of removing the stamp 102a. That is, the sequence of these foregoing steps is not limited by the embodiment.

In addition to the single-layer spacers, one or more layers of spacers can be formed on the single-layer spacers to obtain multi-layer spacers by repeating the foregoing processes. The multi-layer spacers have a slope, and thus makes the shape of the spacers more flexible.

Furthermore, the stamp used in the invention is not limited to the plate-shaped stamp as illustrated in FIG. 6. Other types of the stamp, like a roller-shaped stamp, also can be applied in the invention.

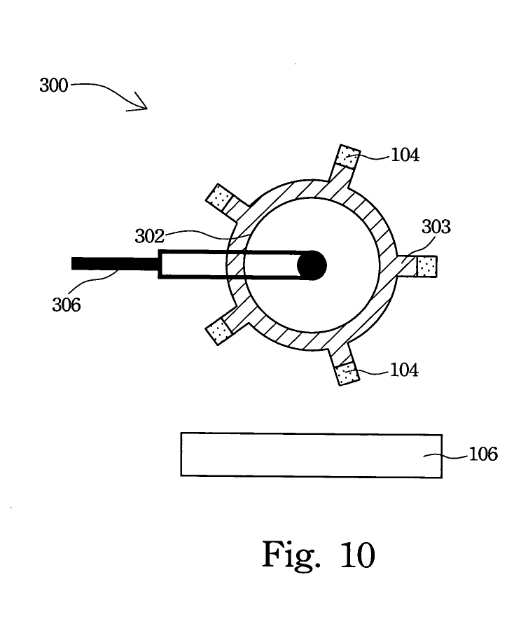

FIG. 10 illustrates a schematic view of another embodiment of the stamp of the invention. As illustrated in FIG. 10, a stamp 300 is roller-shaped. The stamp 300 has a roller 302, and a surface of the roller 302 has several relief geometries 303. The roller-shaped stamp 300 adsorbs the spacer material 104. As described above, the spacer material 104 is made as a solution for being spread on the relief geometries 303. Alternatively, the spacer material 104 can be made as a stamp pad. The stamp 300 is pressed against the stamp pad, and thus the relief geometries 303 adsorb the spacer material 104.

And then, a contacting procedure is carried out to transfer the spacer material 104 onto the substrate 106. The stamp 300 with the spacer material 104 thereon is first brought into contact with the substrate 106, and then the roller 302 is rolled on the substrate 106. For example, a handle 306 of the stamp 300 is pushed to roll the roller 302, and the spacer material 104 is thus left on the substrate 106.

The method of the invention omits the conventional exposure and development processes and thus saves the processing time. In addition, the method forms the spacers only in their correct positions and thus saves the spacer material.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method of manufacturing spacers of a liquid crystal display, the method comprising:
applying a spacer material on a stamping surface of a stamp having relief geometries on the stamping surface;
contacting the stamping surface with a substrate thereby leaving the spacer material on the substrate; and
curing the spacer material on the substrate.

2. The method of claim 1, wherein the stamp is made by the following steps:
forming a master mold having at least one slot;
covering the master mold with a molding material to fill the slot with the molding material;
solidifying the molding material; and
separating the solidified molding material from the master mold.

3. The method of claim 2, wherein the molding material is solidified by a light irradiation.

4. The method of claim 3, wherein the molding material is solidified by an ultraviolet light irradiation.

5. The method of claim 2, wherein the molding material is solidified by heating.

6. The method of claim 2, wherein the molding material is a polymer.

7. The method of claim 1, wherein a material of the stamp comprises polydimethylsiloxane.

8. The method of claim 1, wherein the stamp is plate-shaped.

9. The method of claim 1, wherein the stamp is roller-shaped.

10. The method of claim 1, wherein the spacer material is an organic polymer.

11. The method of claim 1, wherein the spacer material is an acrylic polymer.

12. The method of claim 1, wherein the step of applying the spacer material on the stamping surface comprises spreading the spacer material onto the stamping surface.

13. The method of claim 1, wherein the step of applying the spacer material on the stamping surface comprises pressing the stamp against a stamp pad, wherein the stamp pad contains the spacer material.

14. The method of claim 1, wherein the spacer material is cured by heating.

15. The method of claim 1, wherein the spacer material is cured by a light irradiation.

16. The method of claim 15, wherein the spacer material is cured by an ultraviolet light irradiation.

17. The method of claim 1, wherein the method further comprises separating the spacer material from the stamp after the spacer material is stamped onto the substrate.

18. The method of claim 17, wherein the stamp is separated from the spacer material before the spacer material is cured.

19. The method of claim 17, wherein the stamp is separated from the spacer material after the spacer material is cured.

20. The method of claim 1, wherein the method further comprises repeating the steps of contacting and curing to stack the spacer material.
